(19) United States
(12) Patent Application Publication
(10) Pub. No.: US 2006/0186870 A1
(43) Pub. Date: Aug. 24, 2006

(54) Regulating switching regulators by load monitoring

(75) Inventor: Hassan B. Shami, Tracy, CA (US)

Correspondence Address: PILLSBURY WINTHROP SHAW PITTMAN LLP, P.O. BOX 10500, MCLEAN, VA, 22102, US

(73) Assignee: CALIFORNIA MICRO DEVICES, Milpitas, CA (US)

(21) Appl. No.: 11/349,732

(22) Filed: Feb. 7, 2006

Related U.S. Application Data
(60) Provisional application No. 60/650,945, filed on Feb. 7, 2005.
(60) Provisional application No. 60/650,925, filed on Feb. 7, 2005.

(51) Int. Cl. G05F 1/40; G05F 1/56

(52) U.S. Cl. 323/284

(57) ABSTRACT

Apparatus and methods for controlling a voltage regulator are disclosed. Output voltage of the regulator can be controlled by monitoring headroom voltage measured as the difference of a fixed reference voltage and the output voltage. The fixed reference voltage can be provided as using a current source to drive a resistor and the difference voltage may be measured across the current source. In this manner, the output voltage level may be accurately controlled with few components, resulting in reduced power consumption, increased efficiency and improved die utilization in ICs.

### CROSS-REFERENCE TO RELATED APPLICATION

This application claims the benefit of prior U.S. Provisional Application Ser. No. 60/650,945, filed Feb. 7, 2005 and U.S. Provisional Application Ser. No. 60/650,925, filed Feb. 7, 2005, both provisional applications incorporated herein by reference. The present application is also related to the copending U.S. Utility patent application ______, entitled Automatic Voltage Selection for Series Driven LEDs, filed on even date herewith and incorporated herein by reference.

### BACKGROUND OF THE INVENTION

1. Field of the Invention

The present invention relates to power management and more particularly to power management circuits in integrated circuits.

2. Description of Related Art

A stable voltage level is often required to maintain a desired performance level in many electronic applications and voltage regulators are commonly used to control voltage levels of power supplies. Voltage levels in battery powered devices, in particular, can vary substantially based on charging level of the battery. Variations in voltage may affect legibility of display systems and quality of playback in audio devices. In conventional systems powered by unstable or varying power sources, voltage regulators are used to provide more consistent power supplies.

Referring to FIG. 1, a representation of a typical prior art switching regulator is shown. An output voltage 107 is provided as the voltage maintained on a capacitor 106. The regulated output 107 is derived from an input voltage 103 by cycling a switching FET 113 using controller circuits 100, 101. When the switching FET 113 is closed, a current flows through an inductor 104. When the switching FET 113 is opened, a transient increase in voltage is observed across the inductor 104. This increase in voltage causes the capacitor 106 to be charged through a diode 105. At some point, the voltage across the inductor 104 falls to a level that reverse biases the diode 105. The frequency at which the switching FET is switched is selected to maintain a specified output voltage level.

The presence of a load 108 on the output voltage 107 impacts the selection of switching frequency. The effect of a variable load is counteracted by providing a feedback circuit that controls the charging of the capacitor 106. Therefore, a bridge circuit 109, an amplifier 120, a reference voltage source 110 and a comparator 130 are used for adjusting the clocking frequency to maintain a stable output voltage 107.

Inclusion of these feedback and control components reduces regulator efficiency, increases power dissipation with resulting temperature increases and increased die usage in a semiconductor device.

### SUMMARY OF THE INVENTION

The present invention resolves many of the problems associated with switching voltage regulators and provides low cost solutions for regulating voltages while minimizing overall total power dissipation in battery-powered devices such as cellular telephones.

The present invention provides a voltage regulator that is controlled by monitoring voltage levels in a load through which a known current flows. The voltage in the load provides a feedback signal to a driving IC that may be used to control voltage output level. Thus, the output voltage level may be easily controlled with fewer components, resulting in reduced power consumption, increased efficiency and improved die utilization in ICs.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a schematic drawing of a prior art voltage regulator; and

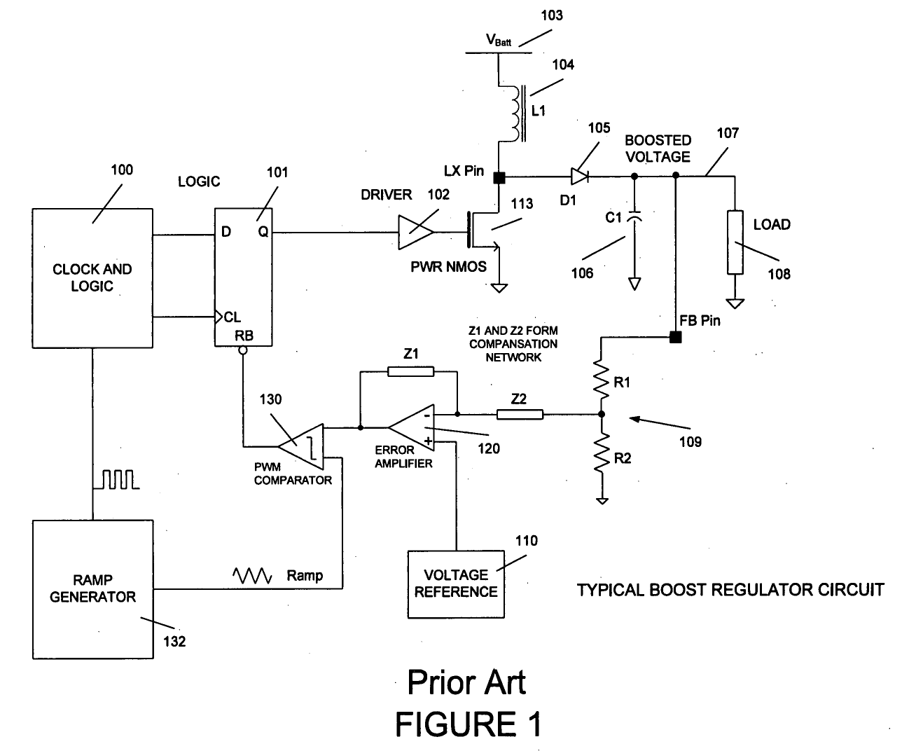

FIG. 2 is a schematic drawing showing an example of a voltage regulator according to embodiments of the invention;

FIG. 3 is a graph plotting output voltage, LED current and control against time in one example of an embodiment of the invention; and

FIG. 4 is a schematic drawing showing a headroom detector according to aspects of the invention.

### DETAILED DESCRIPTION THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention. Where certain elements of these embodiments can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the components referred to herein by way of illustration.

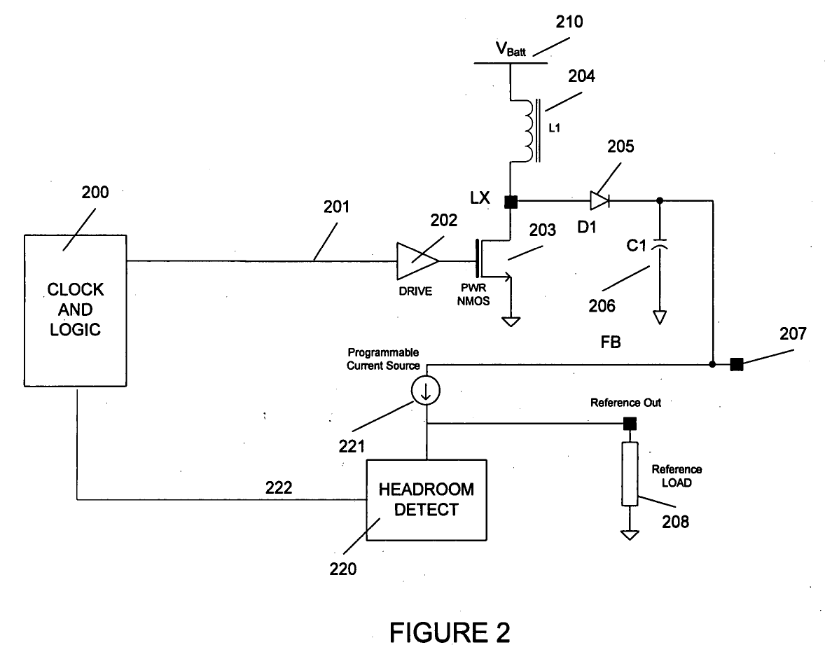

Referring to FIG. 2, an example of a voltage regulator according to one embodiment of the present invention is depicted. In this example, control logic 200 provides a switching signal 201 that is received by a driver 202 for switching an FET 203. The frequency and duty cycle of the switching signal 201 are factors that can be used to control the voltage level of an output voltage 207 for a selected electrical load. Because variations in the electrical load may affect the level of the output voltage 207, certain embodiments of the present invention provide a feedback system for regulating the output voltage 207 under fixed and variable load conditions.

In certain embodiments, a current source 221 is provided to drive a reference load 208. The current source typically provides a selected current to the reference load 208 that causes a voltage drop across the reference load 208. For fixed resistive loads, the voltage drop can be calculated given the current produced by the current source 221. The difference between the output voltage 207 and the voltage dropped across the reference load 208 may be measured across the current source 221. This difference voltage is referred to hereinafter as the “headroom voltage.” In certain embodiments, the headroom voltage can be monitored to regulate the output voltage 207. In at least some embodiments, a programmable voltage is provided, wherein the output voltage 207 may be selected by varying the reference load 208.

In the example provided in FIG. 2, headroom voltage is monitored by a headroom detect component 220 that activates a headroom detect signal 222 upon detecting a minimum headroom voltage across the current source 221. The control logic 200 may adjust the duty cycle and switching frequency of the switching signal 201 based on the state of the headroom detect signal 222. In certain embodiments, the headroom detect signal 222 has an analog component indicative of the headroom voltage level. In certain embodiments, the headroom detect signal 222 is a digital signal encoded with one or more bits of information using any suitable coding scheme, including pulse width modulation, ASCII, BCD and pulse frequency modulation. In certain embodiments, the headroom detect signal 222 provides two states (ON and OFF) indicating whether or not the headroom voltage is greater than a threshold level.

In many embodiments, when the headroom detect signal 222 indicates that the output voltage 207 has exceeded a selected threshold, the rate of charging of capacitor 206 is decreased by a selected amount. Additionally, the rate charging of the capacitor 206 is typically increased when the headroom detect signal 222 indicates that output voltage 207 has dropped below the selected threshold. Therefore, by monitoring the headroom voltage, the output voltage 207 may be maintained around the threshold level. In certain embodiments, increases and decreases in charging may be selectively delayed and the proportion by which charging rates are altered delays can be configured based on system requirements.

It will be appreciated that the rise and fall of the output voltage 207 around the threshold voltage may appear as an alternating current (“AC”) component superimposed on a direct current (“DC”) voltage. Thus, in at least some embodiments, the AC component is removed using any commonly known filtering circuits.

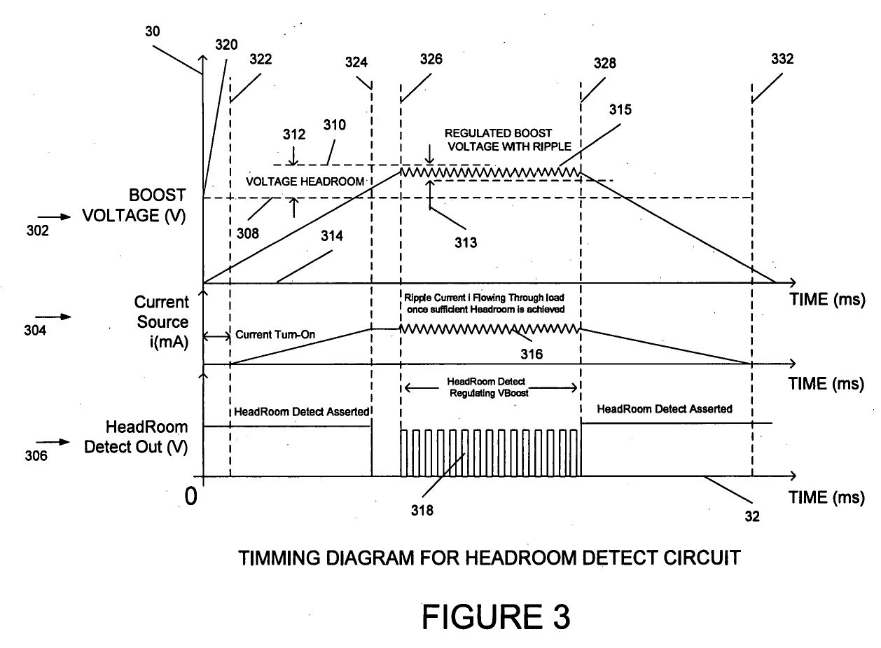

Now referring to FIGS. 2 and 3, timing relationships of various signals may be better understood using the example of an embodiment provided in FIG. 2. The timing diagram of FIG. 3 illustrates typical relationships of output voltage 207, source current 304 and headroom detect signal 222 against time 32. At a first time 320, when the output voltage 207 has a starting voltage level 314, headroom detect signal 222 is asserted, indicating that the output voltage is below a preferred minimum operating value. It will be appreciated that, in at least this example, an activated headroom detect signal 222 indicates that the voltage threshold has not been exceeded. Headroom detect signal 222 is typically received by the control logic 200 and, at some point determined by control logic 200 configuration, the switching signal 201 may begin clocking the FET 203 with a frequency and duty cycle calculated to increase the output voltage 207. It will be appreciated that the operation of the control logic 200 may be programmed by software or through configuration information provided at time of manufacture, initialization or by some other input method. Thus, the precise time at which the switching signal 201 begins cycling may be controlled by a programmed variable. It will also be appreciated that the duty cycle, frequency of switching and other characteristics of the switching signal 201 may be manipulated by software or other control to shape characteristics including, for example, ramp up of the output voltage 207 as it climbs to a preferred operating voltage level.

In the example, the output voltage reaches a preferred operating voltage 308 at a point in time 324 and headroom detect signal 222 is cleared. In some embodiments, the headroom detect signal may be used to control capacitor 27 is charging rates. In response to the change in headroom detect signal 222, the control logic 200 may modify the characteristics of the switching signal 201 to achieve operation within a desired tolerance 312 of the preferred operating voltage 308. It will be appreciated that an AC component 315 may be present on the output voltage 207. In at least some embodiments of the invention, the control logic 200 may be configured to adapt the characteristics of the switching signal 201 to minimize the amplitude associated with the AC component 315. For example, the amplitude of the AC component 315 may be reduced by using a higher frequency switching signal 201 combined with a low-pass filter.

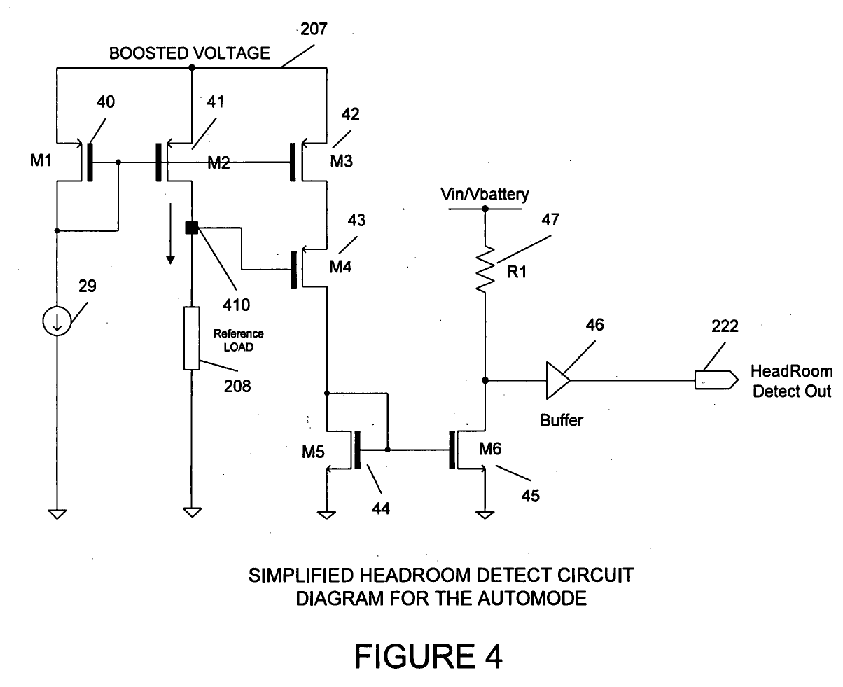

The schematic drawing of FIG. 4 shows an example of a headroom detect circuit implemented in certain embodiments of the invention. A current source 29 sets the current in FET M1 40. This current is mirrored in FET M2 41 and FET M3 42. The current flowing in M3 42 sets a current in FET M5 44 through FET M4 43. M4 43 acts as a switch, being driven by the reference load output pin 410. FET M6 45 mirrors the current through M5 44, causing a voltage drop across resistor R1 47. A buffer 46 sets headroom detect signal 222 based on the voltage drop measured across R1 47, wherein the buffer 46 provides either an active high or active low control signal as required. As the output voltage 207 increases and sufficient headroom is attained, headroom detect signal 222 is cleared. M4 43 turns off as output voltage 207 is increased, thereby causing M6 45 to turn off. With M6 45 turned off, voltage across R1 47 drops causing the input to the buffer 46 to rise to level of battery voltage 210 until the input voltage crosses a selected switchover point. This change is detected by buffer device 46 and causes the clearing of the headroom detect signal 222. It will be appreciated that the switchover point of the buffer device 46 can be selected as desired

It should be apparent that aspects of the invention provide, not only for automatic selection of output voltage, but also for dynamic selection of output voltage. This aspect not only provides flexibility in design, but also optimizes power consumption in devices in certain embodiments. Power consumption can be minimized because the headroom voltage is always maintained at minimum levels required by operating conditions.

Although the present invention has been particularly described with reference to embodiments thereof, it should be readily apparent to those of ordinary skill in the art that changes and modifications in the form and details thereof may be made without departing from the spirit and scope of the invention. For example, those skilled in the art will understand that variations can be made in the number and arrangement of components illustrated in the above block diagrams. It is intended that the appended claims include such changes and modifications.

What is claimed is:

1. A method for regulating a voltage comprising the steps of:
receiving a regulated voltage at a current source, wherein the current source provides a current to a reference load;
measuring a headroom voltage across the current source, and
adjusting the regulated voltage based on the measured headroom voltage.

2. The method of claim 1, wherein the regulated voltage is received from a switching regulator controlled by a clocking signal.

3. The method of claim 2, wherein the step of adjusting includes modifying switching frequency of the clocking signal.

4. The method of claim 2, wherein the step of adjusting includes modifying duty cycle of the clocking signal.

5. The method of claim 1 wherein the step of adjusting includes
selectively increasing voltage level of the regulated voltage responsive to assertion of a headroom detect signal; and
selectively decreasing voltage level of the regulated voltage when the headroom detect signal is cleared.

6. The method of claim 5, wherein
the headroom detect signal is asserted when the headroom voltage falls below a minimum desired headroom voltage, and
the headroom detect signal is cleared when the output voltage reaches a preferred operating voltage.

7. An apparatus for regulating a voltage comprising:
a regulator for providing an output voltage;
a current source for receiving the output voltage and providing a current to a reference load;
a headroom detect circuit for providing a control signal indicative of a headroom voltage measured across the current source; and
control logic responsive to the control signal and configured to maintain the output voltage within a desired operating tolerance.

8. The apparatus of claim 7, wherein the regulator is a switching regulator and the control logic provides a clocking signal to the regulator.

9. The apparatus of claim 8, wherein the controller controls the output voltage by adjusting characteristics of the clocking signal, including switching frequency and duty cycle.

10. A method for regulating voltage comprising the steps of:
receiving an output voltage provided by a regulator;
measuring a difference between the output voltage and a reference voltage; and
adjusting the output voltage to maintain the difference voltage at least equal to a desired minimum voltage.

11. The method of claim 10, wherein the output voltage is controlled by frequency of a clocking signal provided to the regulator.

12. The method of claim 10, wherein output voltage level is responsive to a duty cycle of a clocking signal provided to the regulator.

13. The method of claim 10, wherein the difference is measured across a current source.

14. The method of claim 10, wherein the regulator receives a signal indicative of the difference.

15. The method of claim 14, wherein the signal includes an analog component.

16. The method of claim 14, wherein the signal is a binary signal.

17. The method of claim 14, wherein the signal is digitally encoded.

18. The method of claim 14, wherein the signal is encoded using one or more modulations including pulse width modulation and pulse frequency modulation.

19. The method of claim 10, wherein the step of adjusting includes
increasing duty cycle of a clocking signal when the difference is less than the desired minimum voltage, wherein the clocking signal controls the output voltage; and
selectively decreasing the duty cycle of the clocking signal when the difference is greater than a predetermined value.

20. The method of claim 14, wherein the step of adjusting includes selecting duty cycle and clocking frequency of a clocking signal responsive to the control signal, wherein the clocking signal controls the output voltage.
